(19) United States
(12) Patent Application Publication
(10) Pub. No.: US 2013/0013198 A1
(43) Pub. Date: Jan. 10, 2013

(54) Navigation System Creating A Route Based On Certain Criteria Along The Route

(76) Inventor: John B. Adrain, Spokane, WA (US)

(21) Appl. No.: 13/542,262

(22) Filed: Jul. 5, 2012

Related U.S. Application Data
(60) Provisional application No. 61/505,728, filed on Jul. 8, 2011.

(51) Int. Cl. G01C 21/00; G01C 21/34

(52) U.S. Cl. 701/468; 701/400; 701/540; 701/537

(57) ABSTRACT

This invention includes a method of creating a navigation route based on certain criteria along several possible routes. One such criterion can be property values along routes. A navigation system using such a method can operate either off-line, with property values retrieved from a database previously, or on-line, with real-time retrieval of property values from a database. The retrieval is done using a communication interface. The system can include a GPS unit for determining the present location of the system, and the system with such a GPS unit can create a property-value-based navigation route from the present location to the destination without the driver being required to know the present location. Other criteria can include values of cars, boats, or airplanes registered at locations along routes. Routes along which are residences of criminals can be avoided.

### CROSS REFERENCE TO RELATED APPLICATION

This application claims priority to U.S. Provisional Application No. 61/505,728, filed Jul. 8, 2011 (EFS ID 10480020).

### TECHNICAL FIELD

This invention relates to a navigation system which creates one or more potential routes based on certain criteria or types of criteria along said potential routes of travel.

### BACKGROUND OF THE INVENTION

When a navigation system creates a route, the route is often created to be the shortest or fastest from those available. Often, such a created route will not be the safest because it may lead through an unsafe neighborhood. A driver may choose to go by a longer, yet safer, route rather than by a shorter, but more dangerous, one. A problem then becomes determining which route is safer and which is more dangerous. A driver that is unfamiliar with the created route might be very interested in the perceived safety of the neighborhood through which the route goes.

Safety aside, when a driver is faced with many possible choices for a route to the driver's destination, the driver might prefer to drive through a more affluent neighborhood, even if it is not the shortest route. But, unless the driver looks up the property values of the neighborhoods along the several proposed routes, the driver will not know which neighborhood is more affluent. Looking up the property values of several neighborhoods is time-intensive and requires the driver to know addresses of properties along the several routes.

Other aspects and implementations are contemplated.

While the invention was motivated in addressing navigational issues in selected desired possible routes based upon one or more pre-determined criteria, it is in no way so limited. The invention is only limited by the accompanying claims as literally worded, without interpretative or other limiting reference to the specification, and in accordance with the doctrine of equivalents.

### BRIEF DESCRIPTION OF THE DRAWINGS

Preferred embodiments of the invention are described below with reference to the following accompanying drawings.

FIG. 1 is a block diagram of one example of a method embodiment of this invention;

FIG. 2 is a block diagram of one example of a system embodiment of this invention including a processor and communication interface;

FIG. 3 is a block diagram of an example of a system embodiment of this invention as shown in FIG. 2 and further including a GPS and a navigational route display for the user;

FIG. 4 is a depiction of an example of a display which may be utilized in practicing embodiments of this invention; and

FIG. 5 is a depiction of one of many possible displays 190 which may be utilized in embodiments of this invention.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an” and “the” as used in the claims herein are used in conformance with long-standing claim drafting practice and not in a limiting way. Unless specifically set forth herein, the terms “a”, “an” and “the” are not limited to one of such elements, but instead mean “at least one”.

This invention is a method of creating a navigation route, comprising the step of selecting a route from several possible routes based on property values along the routes. In a further embodiment of the invention, a route with higher property values along the route is selected over a route with lower property values along the route. In another embodiment of the invention, a route with lower property values along the route is selected over a route with higher property values along the route.

In a further embodiment of the invention, if a segment of the navigation route is on a limited-access highway, that segment is not selected based on property values along the segment.

This invention is also a navigation system comprising a communication interface that can retrieve information on property values from a database, and a processing unit that selects one navigation route from several possible routes based on property values along the several possible routes.

In a further embodiment of the invention, the communication interface is wireless. In a further embodiment of the invention, the communication interface comprises a cell phone protocol, an Internet protocol, or a Bluetooth protocol. In a further embodiment of the invention, the communication interface comprises a GSM, CDMA, TDSM, or Wi-Fi protocol.

A further embodiment of the invention further comprises a GPS unit that determines a present location of the system.

In a further embodiment of the invention, the processing unit selects a route with higher property values along the route over a route with lower property values along the route. In another embodiment of the invention, the processing unit selects a route with lower property values along the route over a route with higher property values along the route.

In a further embodiment of the invention, if a segment of the navigation route is on a limited-access highway, the processing unit does not select that segment based on property values along the segment.

This invention is also a method of creating a navigation route, comprising the step of selecting a route from several possible routes based on values of vehicles selected from a group consisting of cars, boats, and airplanes, where the vehicles are registered at locations along the possible routes.

This invention is also a method of creating a navigation route, comprising the step of avoiding a route from several possible routes if a criminal lives at a location along such route.

This invention can be used to create a navigation route based on property values along the route. The higher the property values, the more affluent the neighborhood can be perceived, and thus, the more safe. Conversely, a route can be perceived as less and less safe the lower the property values along the route are.

It will be appreciated by those of ordinary skill in the art that property value may refer to real or personal property (cars, boats, airplanes, mobile homes, etc).

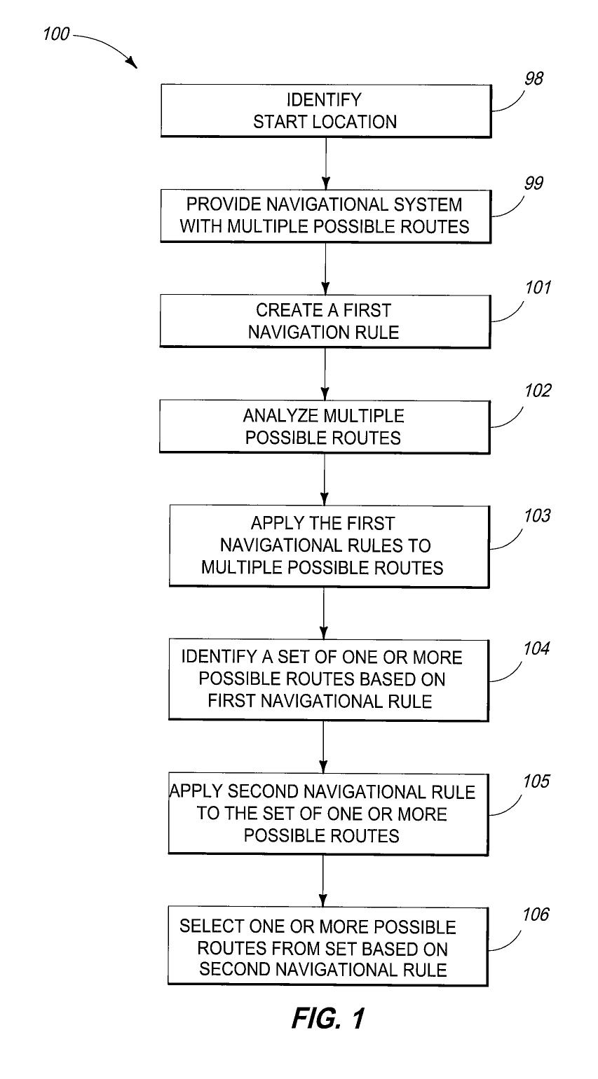

FIG. 1 is a block diagram of one example of a method embodiment 100 of this invention, illustrating creating a navigational rule 101, analyzing multiple possible navigational routes 102, applying the navigational rule created to the multiple possible routes 103, then identifying and/or selecting one or more possible routes 104 for the user to take based upon the application of the navigational rule 103. In further embodiments, a list of possible routes based on the first navigational rule can become the set of possible routes and to which a second navigational rule is applied 105, to select a subset of one or more possible navigational routes 106 from the first set of possible navigational routes. It should be noted that this invention would further contemplate the application of additional possible navigational routes based upon additional rules or criteria.

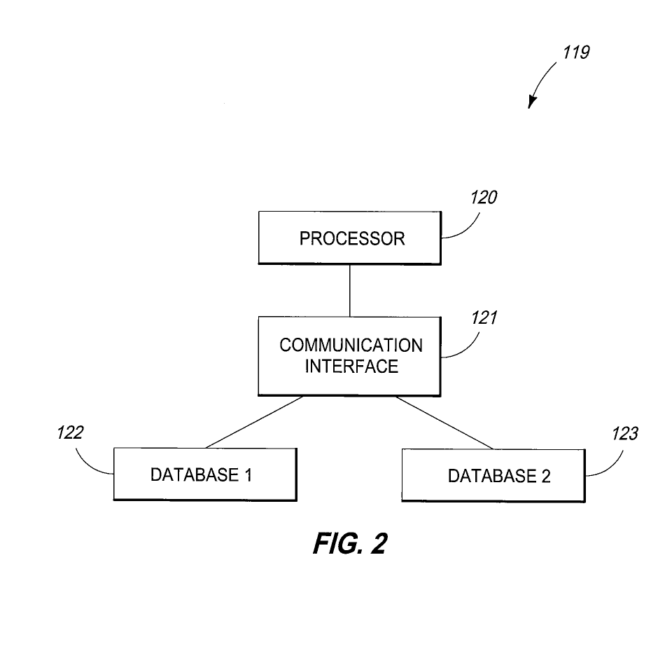

FIG. 2 is a block diagram of an example of a system embodiment of this invention 119, illustrating a communication interface 121 operatively connected to a processor 120 and to a first database 122 and a second database 123. The processor 120 and the first database 122 and second database 123, may be any one of a number of different types of known processors or databases with no one in particular being required to practice this invention.

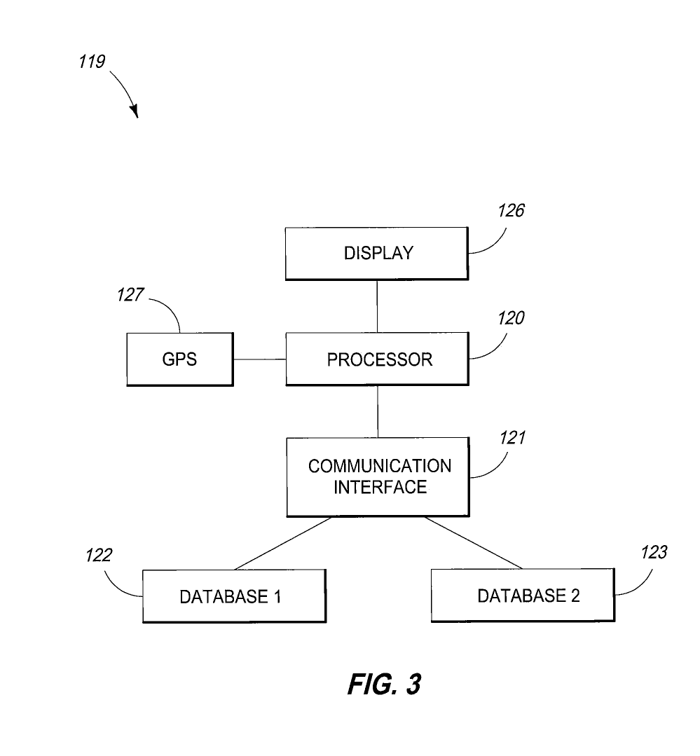

FIG. 3 is the block diagram example of an embodiment illustrated and described in FIG. 2, only further illustrating display 126 operatively connected to the processor 120, and a GPS (Ground Positioning System) 127 also operatively connected to the processor 120.

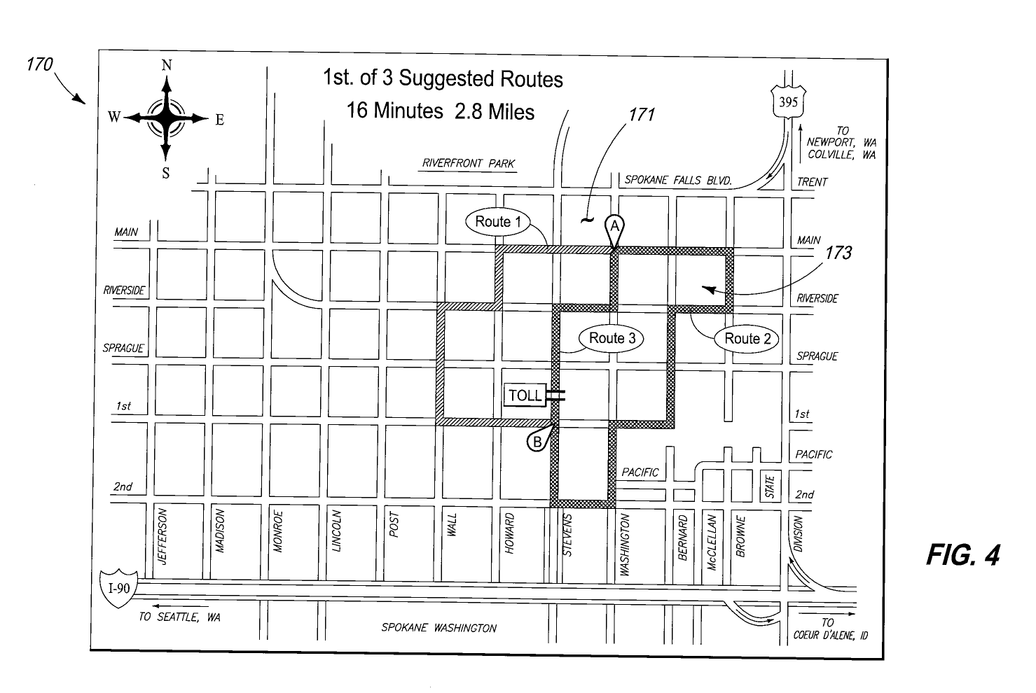

FIG. 4 is a depiction of an example of a display 170 which may be utilized in practicing some embodiments of this invention, illustrating display screen 171, and map 173. It will be appreciated that this display may be as part of a stand alone navigation system, or contained within a computing device, cellular phone, or any one of a number of different devices.

The map 173 illustrates that a current location and a destination have been identified, and one or more possible routes identified. For each of the possible routes an estimated mileage and drive time are provided. For example the directions and estimated mileage and drive time are provided for Route 1, and if Route 2 is selected, the directions and estimated mileage and drive time would then be provided for Route 2, and so on. In some embodiments of this invention the system would determine alternative routes based on the use of property values (real or personal) associated or correlated along each potential route.

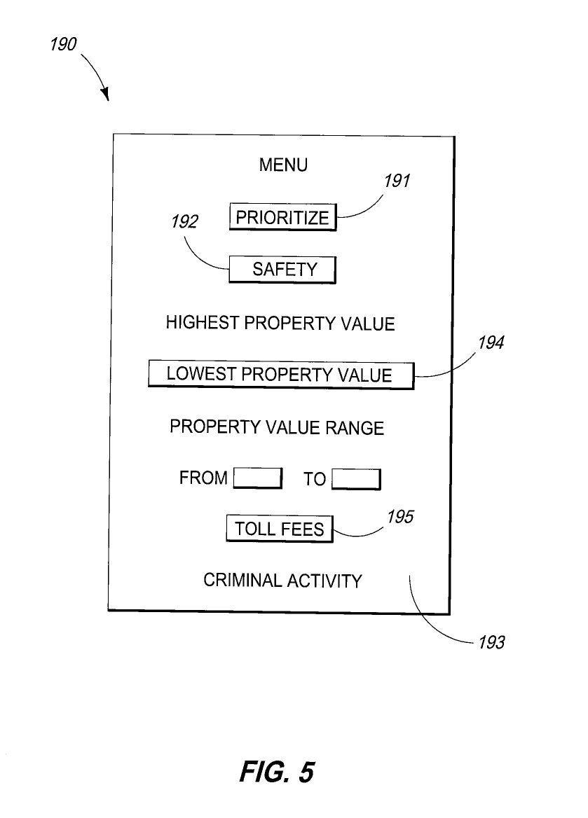

FIG. 5 is a depiction of one of many possible displays 190 which may be utilized in embodiments of this invention, showing a Menu on a display screen 193, with a Prioritize selection 191 which allows you to utilize a prioritize feature in determining or suggesting possible routes to take. Prioritize is not the only criteria for sorting possible routes. In the Prioritize selection 191, examples of selection criteria that may be included in embodiments of this invention are that a user can choose the Safety selection 192 as one criteria by which to prioritize, or choose Toll Fees 195 or Criminal Activity. This menu can be utilized to prioritize and or combine sets or subsets to use or apply navigation rules. For example if one chooses the Safety selection 192, a secondary priority or second navigation rule may be distance or time traveled so that the shortest distance within the Safety selections is shown or displayed first.

In this example of the embodiment, under the Safety selection 192 the user may be able to choose between highest or lowest property value 194 for example, as a criteria in determining safety. Another option that may be included in the menu may be the police accident reports which may report the incidence of accidents along a particular route, as a criteria in determining the priority recommended route(s).

One embodiment of the invention can entail comparing the possible routes to a destination and choosing one based on property values along the routes. One possibility is selecting the route with higher property values along the route compared to other routes.

Another possible reason for using property values to create a route can be related to tax revenue. The higher the property values in a neighborhood, the more property taxes that such a neighborhood can collect. With a higher property tax income, such a neighborhood can likely deploy more police officers to patrol that neighborhood, thus presumably making such a neighborhood more safe. A neighborhood with lower property values can collect less property taxes. With less property tax income, such a neighborhood might not be able to hire as many police officers. With less police officers patrolling such a neighborhood, the crime in such a neighborhood might be higher, thus making the neighborhood less safe.

Another possible reason to use property values in creating a navigation route can be to select a route that will lead through a more affluent neighborhood, and thus possibly be a more pleasant and aesthetic drive. Neighborhoods with higher property values can generate higher property tax income, as mentioned above, and be able to afford various community services that keep the neighborhoods attractive. Property owners, whether of individual residences or business properties, in neighborhoods with higher average property values can have the financial ability to maintain such properties in good condition, thus making a drive along such properties more pleasant.

Conversely, property owners in neighborhoods with lower average property values might have less financial ability to maintain such properties in good condition. Such neighborhoods might have less property tax income to dedicate to community services that maintain and keep neighborhoods attractive. Thus, such a neighborhood can be less attractive for a driver to drive through.

Another possible reason to use property values in creating a navigation route can be to select a route through a center of a city that has lower property values. While seeming counterintuitive at first, especially in light of the previous discussion, this approach may work when creating a route in a large city. In a large city, higher property values can tend to be in the busier sections of the city for various reasons. Lower property values in a city center can tend to be in the less busy sections of the city. Thus, when a driver's route goes through a city center, the driver might prefer the route to go through the parts with lower property values because of less traffic through such parts, as opposed to popular and busy parts of the city center with high property values.

Therefore, another embodiment of the invention can entail comparing the possible routes to a destination and choosing the route with lower property values along it compared to other routes.

When part of a route is on a limited-access highway, property value analysis can be less important for several reasons. First, vehicles traveling on such a highway can do so at a greater speed, thus making it more difficult for others to stop the car, threaten the car's occupants, or do any damage to the car, as might be possible with a car traveling at lower speeds on a regular road. Second, because such a highway is one of limited access, there can be a lower risk that those on the highway are there to threaten others or cause them trouble. Those present on a limited-access highway might be more likely to use it for travel purposes rather than for misdeeds. Thus, if a segment of a possible route is on a limited-access highway, the property value analysis for that segment can be less relevant than on a regular road, and thus can be dispensed with for that segment. In such a case, that segment can be analyzed by other criteria, such as speed or shortest distance rather than property values.

Another embodiment of the invention can be a navigation system that incorporates the above principles. The navigation system can have a communication interface that retrieves information on property values from a database, and a processing unit that selects one route from several possible routes based on property values along the several possible routes. The processing unit can select a route with higher property values along the route, or a route with lower property values along the route. The processing unit could also ignore property-value analysis for a segment of a route that is on a limited-access highway, and analyze that segment using other criteria, as discussed above.

An embodiment of such a navigation system can be an off-line navigation system. The system can include information on property values that was previously retrieved from a database containing such values. The communication interface in such an embodiment can be as simple as looking up such property values in a local database stored in a local, non-transitory computer readable memory such as a hard disk drive, for example, which was previously copied from another database, and communicating such values to the processing unit for the route selection process. The communication interface in such an embodiment can be the software integration of, or interface between, the database and processing unit. An off-line navigation system can be capable of downloading updated property value information from a remote database containing current values.

Another embodiment of such a navigation system can be an on-line navigation system. Instead of storing property values in a local database, the system can use the communication interface to retrieve property values from a remote database in real time as the navigation system is operating. Examples of on-line databases include, but are not limited to, Domania (www.domania.com); Cyberhomes (www.cyberhomes.com); AccuriZ (www.accuriz.com); and Realtors Property Resource (www.narrpr.com).

The navigation system can also include both real-time retrieval of information from an on-line database and a local database that can be utilized if the remote database is not used. Possible reasons for using the local, off-line, database as opposed to the remote, on-line, database include, but are not limited to, unavailability of the remote database, for example due to maintenance; interruption of the communication interface; the desire to conserve bandwidth of the communication interface by not using the interface; or congestion of the communication interface, where retrieval from the remote database takes a long time.

In use, such a navigation system can prove to be useful to realtors or others employed in a field related to the buying, selling and/or appraisal of real estate. For example, such an embodiment of the navigation system can optionally include a processor that can prioritize one or a plurality of the criteria disclosed herein when generating a route to be traveled. For example, a realtor plotting a route to be taken while showing homes to a prospective buyer may select the locations of homes currently being sold, the price of homes currently available for sale, or a combination thereof. Thus, according to such an embodiment, the navigation system can generate a route having the greatest number of homes for sale along the way, or a route having the greatest number of homes within a price range specified by the realtor along the way.

Although the embodiments discussed above describe using the values and prices of residential homes for generating the navigation route, it is to be understood that the values and prices of commercial and/or industrial buildings and facilities can be used instead of, or in addition to the values and prices of residential homes without departing from the scope of the invention.

Further, although the navigation system and method can be useful to realtors and others involved in real-estate transactions, law enforcement, building inspectors, fire departments and other municipal entities; as well as utility service providers such as electric service contractors, natural gas service contractors and the like can also make use of the navigation system and method described herein. For example, upon arriving at a location of a standoff involving a person barricaded within his home (or any other building), a law-enforcement vehicle may be stopped in front of that particular residence. Using GPS coordinates, the navigation system can identify the address of the residence in question, and automatically retrieve various information about the residence without human intervention. For instance, the navigation system can retrieve information from a database of information populated as part of the permitting process for construction/renovations, from government records, or from any other source of information that is accessible over a communication network. Examples of such information retrieved by the navigation system include, but are not limited to: a floor plan depicting the layout of the residence or other building, an electrical schematic identifying where electricity is introduced to the residence or other building, a map identifying the location of gas lines, water lines, telephone lines, cable lines, fiber optic lines or any other type of infrastructure is located.

The communication interface can be wired or wireless. A wireless communication interface can comprise an Internet protocol, a Bluetooth protocol, or a cell phone protocol. A wireless communication interface can comprise a Wi-Fi protocol, a GSM protocol, a TDMA protocol, or a CDMA protocol.

Another embodiment of the system can further comprise a GPS unit that detects the present location of the unit. Such a navigation system can create a route to a destination from a present location of the system even if the driver is not sure of the present location.

Another embodiment of the invention can utilize the values of boats, cars, and/or airplanes, where they are registered, instead of home values, to create a route. Owners of boats or airplanes can be perceived as wealthy and more likely to keep the boats or airplanes in safe neighborhoods. Thus, a route that leads through such a neighborhood can be perceived as more safe.

Cars of differing values can be registered, whether expensive or inexpensive. With many car values stored in a database, the route navigation method can be analogous to that according to home values as discussed above. If car registration is optional, it is possible that only owners of expensive cars would register them. This scenario could thus be analogous to that of boats or airplanes discussed above.

In another embodiment of the invention, the navigation system can check a database of residences of criminals and avoid such locations in the created route. Residences of criminals can be deemed unsafe because of the proximity of criminals, so when the navigation system creates a route that avoids such locations, the route can be perceived as more safe.

It will further be appreciated by those of ordinary skill in the art that there may be one or more sources of information or data from which to identify a given prospective route (such as based on property value), some more readily available than other data, and it may be the availability of relevant data that may determine the preferred source to then correlate back to the criteria. For example publicly available licensing records may indicate the presence of luxury items such as larger boats, which in turn may be correlated to a desired criteria of higher real property value, all within the contemplation of embodiments of this invention. It will also be appreciated by those of ordinary skill in the art that the correlation may be an inverse correlation, for example if a particular navigational route includes a higher density of persons with a criminal record that may inversely correlate to the real or personal property values along that potential route.

These other sources of data that may directly (or indirectly correlate to the primary criteria) may be accessed and may include such source data as building permit data, appraisal data, Department of Motor Vehicle (DMV) data, criminal data, tax records, patent filing information, criminal and sex offender records, health or medical records (including psychological records), power usage, water usage, business licenses, insurance statistics, ATF records, FFL licenses, ham radio licenses, mineral right data, reg light camera records, accident statistics and/or data, marriage/divorce records, police records/data, city and county records/data, criminal statistic records/data, and others.

It is still further within the contemplation of embodiments of this invention to utilize one or more sets and subsets of criteria for determining a desired navigational route of travel; for example if a property value determination yields more than one prospective route, the system may then determine which of those routes has a lower density or incidence of persons with a criminal background or who are registered sex offenders.

As will be appreciated by those of reasonable skill in the art, there are numerous embodiments to this invention, and variations of elements, components and combinations, which may be used, all within the scope of this invention.

One embodiment of this invention, for example, is a method of creating a navigation route, comprising the step of selecting a route from several possible routes based on property values along the routes. This selection may be based on criteria such as: wherein a route with higher property values along the route is selected over a route with lower property values along the route; or wherein a route with lower property values along the route is selected over a route with higher property values along the route. In applying a second navigational rule, a route may be selected based for example on the presence of a limited-access highway.

In other embodiments, a navigation system may be comprised of a communication interface that can retrieve information on property values from a database, and a processing unit that selects one navigation route from several possible routes based on property values along the several possible routes. This system embodiment may also for example be: wherein the communication interface is wireless; wherein the communication interface comprises a cell phone protocol, an Internet protocol, or a Bluetooth protocol; and/or wherein the communication interface comprises a GSM, CDMA, TDSM, or Wi-Fi protocol. This system may also further comprise a GPS unit that determines a present location of the system; a system wherein the processing unit selects a route with higher property values along the route over a route with lower property values along the route; and/or a system wherein the processing unit selects a route with lower property values along the route over a route with higher property values along the route.

A still further embodiment may be a method of creating a navigation route, comprising the step of selecting a route from several possible routes based on values of vehicles selected from a group consisting of cars, boats, and airplanes, where the vehicles are registered at locations along the possible routes. This method of creating a navigation route may further comprise the step of avoiding a route from several possible routes if a criminal lives at a location along such route.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A method of creating a navigation route, comprising the step of selecting a route from several possible routes based on property values along the routes.

2. The method of claim 1, wherein a route with higher property values along the route is selected over a route with lower property values along the route.

3. The method of claim 1, wherein a route with lower property values along the route is selected over a route with higher property values along the route.

4. The method of claim 1, wherein if a segment of the navigation route is on a limited-access highway, that segment is not selected based on property values along the segment.

5. A navigation system comprising:
a communication interface that can retrieve information on property values from a database, and
a processing unit that selects one navigation route from several possible routes based on property values along the several possible routes.

6. The navigation system of claim 5, wherein the communication interface is wireless.

7. The navigation system of claim 6, wherein the communication interface comprises a cell phone protocol, an Internet protocol, or a Bluetooth protocol.

8. The navigation system of claim 7, wherein the communication interface comprises a GSM, CDMA, TDSM, or Wi-Fi protocol.

9. The navigation system of claim 5 further comprising a GPS unit that determines a present location of the system.

10. The navigation system of claim 5, wherein the processing unit selects a route with higher property values along the route over a route with lower property values along the route.

11. The navigation system of claim 5, wherein the processing unit selects a route with lower property values along the route over a route with higher property values along the route.

12. The navigation system of claim 5, wherein if a segment of the navigation route is on a limited-access highway, the processing unit does not select that segment based on property values along the segment.

13. A method of creating a navigation route, comprising the step of selecting a route from several possible routes based on values of vehicles selected from a group consisting of
cars,
boats, and
airplanes,
where the vehicles are registered at locations along the possible routes.

14. A method of creating a navigation route, comprising the step of avoiding a route from several possible routes if a criminal lives at a location along such route.
